(19) United States
(12) Patent Application Publication
(10) Pub. No.: US 2015/0017564 A1
(43) Pub. Date: Jan. 15, 2015

(54) Electrochemical Conversion Device

(71) Applicants: Uwe Maier, Reutlingen (DE); Andreas Zimmer, Metzingen (DE)

(72) Inventors: Uwe Maier, Reutlingen (DE); Andreas Zimmer, Metzingen (DE)

(73) Assignee: ElringKlinger AG, Dettingen (DE)

(21) Appl. No.: 14/326,241

(22) Filed: Jul. 8, 2014

(30) Foreign Application Priority Data
Jul. 9, 2013 (DE) 102013213399.5

(51) Int. Cl. H01M 8/02; H01M 8/24

(52) U.S. Cl. CPC H01M 8/0208; H01M 8/24
USPC 429/469; 429/467; 429/470; 429/535

(57) ABSTRACT

In order to improve an electrochemical conversion device comprising a plurality of functional elements stacked one upon the other into a stack in a stacking direction and interconnected within the stack, some of which have peripheral areas of sheet material, some of which are arranged in a stacked configuration one upon the other in a stacking direction, forming peripheral stacks, and are interconnected by way of a first element-to-element connection and some others of which are interconnected by way of a second element-to-element connection, in such a manner that the strain placed on the element-to-element connections can be kept as low as possible, it is proposed that one of the functional elements comprise a compensating unit and that the compensating unit comprise at least one deformable element which, by deformation, allows for at least one height compensation in the stacking direction.

### CROSS REFERENCE TO RELATED PATENT APPLICATION

This patent application claims the benefit of German application number 10 2013 213 399.5 of Jul. 9, 2013, the teachings and disclosure of which are hereby incorporated in their entirety by reference thereto.

### BACKGROUND OF THE INVENTION

The invention relates to an electrochemical conversion device, comprising a plurality of functional elements stacked one upon the other into a stack in a stacking direction and interconnected within the stack, some of which have peripheral areas of sheet material, some of which are arranged in a stacked configuration one upon the other in a stacking direction, forming peripheral stacks, and are interconnected by way of a first element-to-element connection and some others of which are interconnected by way of a second element-to-element connection.

Such electrochemical conversion devices are known in the prior art.

In these electrochemical conversion devices, the problem exists that they are subject to variations in pressure and temperature and this imposes very high strain on the element-to-element connections.

In particular, in such electrochemical conversion devices it is necessary to use isolating element-to-element connections, and these present a problem in terms of their mechanical stability.

Hence, the object underlying the invention is to improve an electrochemical conversion device of the kind described at the outset such that the strain placed on the element-to-element connections can be kept as low as possible.

### SUMMARY OF THE INVENTION

In accordance with the invention, this object is accomplished in an electrochemical conversion device of the kind described at the outset by one of the functional elements comprising a compensating unit and by the compensating unit comprising at least one deformable element which, by deformation, allows for at least one height compensation in the stacking direction.

The advantage of the solution in accordance with the invention is seen in that by the use of such a compensating unit, the mechanical stresses acting on the element-to-element connections are either reduced or compensated so that there is less strain on the element-to-element connections and therefore less damage to the element-to-element connections during operation of the electrochemical conversion device.

The compensating unit need not necessarily be arranged adjacent to a stress-sensitive element-to-element connection.

In order for the compensating unit to function as effectively as possible, it is preferably provided for the compensating unit to be connected to the adjacent functional elements on the one hand by way of the first element-to-element connection and on the other hand by way of the second element-to-element connection.

This makes it possible, independently of which of the element-to-element connections has the higher sensitivity to stress, to reduce or substantially relieve these stresses by way of the compensating unit.

In conjunction with the previously described solutions, no details have been provided as to how the compensating unit is to be configured.

One solution that is particularly advantageous provides for the compensating unit to comprise at least one sheet material layer as the deformable element for height compensation.

More advantageously, the compensating unit comprises at least two sheet material layers that are movable relative to each other in the stacking direction.

The at least two sheet material layers can have a variety of different configurations.

For example, one of the sheet material layers or both sheet material layers may be formed into a bead.

In the simplest case, however, the two sheet material layers are configured such that they each extend in a plane when in the undeformed state.

In order to provide for height compensation when deformed, it is preferably provided for the at least two sheet material layers to be interconnected in connection areas and to be movable relative to each other in the stacking direction in movement areas located outside the connection areas.

The connection in the connection areas may be effected for example by one of the sheet material layers transitioning into the other one.

Another advantageous solution provides for the sheet material layers to be interconnected in the connection areas by way of a substance-to-substance bond.

In particular, provision is made for the substance-to-substance bond between the sheet material layers to be located on a side of the compensating unit that faces away from the peripheral area. This is advantageous in that it provides as large as possible an area in which the sheet material layers are capable of deformation.

In particular for creating flat-lying movement areas, it is advantageous for the connection areas of the sheet material layers to be arranged on a side of the compensating unit that faces away from the peripheral area of the respective functional element.

Furthermore, no details have been given so far as to how the movement areas are configured.

An advantageous solution provides for the movement areas of the sheet material layers to lie one on top of the other in a first position and to extend at a distance from one another in at least one second position, wherein different second positions with different distances can be implemented, allowing for the compensation of stresses or tensile loads of different magnitudes.

Within the scope of the solution in accordance with the invention, it is further advantageous for the movement areas to be arranged on a side of the compensating unit that faces towards the peripheral area.

With respect to the connection between the compensating unit and the remaining functional elements it is for example advantageous for one of the sheet material layers of the compensating unit to be connected to the adjacent functional element in the stacking direction by way of a peripheral area and the first element-to-element connection.

It is further advantageous for one of the sheet material layers of the compensating unit to be connected to the adjacent functional element in the stacking direction by way of the second element-to-element connection. No details have been provided so far on the element-to-element connections.

It is preferably provided for one of the element-to-element connections to be an electrically isolating element-to-element connection.

Further, it is preferably provided for another one of the element-to-element connections to be an electrically conductive element-to-element connection.

No details have been given so far as to how the second element-to-element connection is configured.

An advantageous solution provides for the second element-to-element connection to be a substance-to-substance bond.

In particular, provision is made for the second element-to-element connection to comprise a solder connection.

The solder connection may comprise for example a glass solder connection layer so that the second element-to-element connection may be configured as an isolating element-to-element connection.

Another way of configuring the second element-to-element connection is for the second element-to-element connection to comprise a solder layer and an isolation layer, wherein the isolation layer may be a ceramic layer for example.

In this case as well, the second element-to-element connection is an isolating element-to-element connection.

Furthermore, no further details have been given so far on the first element-to-element connection.

For example, provision is made for the first element-to-element connection to be a substance-to-substance bond.

Preferably, the substance-to-substance bond is a welded connection comprising a connection zone.

For example, the peripheral areas of the functional elements are configured such that they extend to end faces succeeding one another in the stacking direction and that the end faces of the respective peripheral stacks are arranged relative to one another such that they are within the connection zone.

Furthermore, provision is preferably made for the connection zone to be configured in surrounding relation with the functional elements of the respective assembly group, i.e. such that it forms a surrounding and tightly sealed connection.

Moreover, it is preferably provided for the connection zone to be configured such that it interconnects all of the peripheral areas of the respective assembly group in a gas-tight manner.

Finally, an advantageous solution provides for an end face area in which the connection zone is formed to extend starting from the end faces of the peripheral areas into the peripheral areas by a distance no greater than that corresponding to twice the thickness of one of the peripheral areas.

Furthermore, the invention relates to a method for manufacturing an electrochemical conversion device from individual functional elements that are interconnected in a stack.

In this method, in accordance with the invention, a second element-to-element connection between some of the functional elements is made first, said second element-to-element connection is subjected to a functional test and thereafter stacking of the functional elements is performed and subsequently any stacked functional elements not yet connected by the second element-to-element connection are interconnected by way of a first element-to-element connection.

The advantage of the solution in accordance with the invention is that it affords the possibility for the functional elements that are at first interconnected by the second element-to-element connection to be tested with respect to their functions and only then for the functional elements to be stacked, wherein the stacked functional elements, for example all or only some of the functional elements that are not yet connected by the second element-to-element connection, are interconnected by a first element-to-element connection.

This solution is advantageous in that it permits selecting for example as the second element-to-element connection the element-to-element connection that is technically difficult to perform and therefore leads to a substantial defect rate in making the connection, meaning that any connections found to be defective can be discarded and precluded from use in building the stacks of functional elements.

In particular, it is then possible to select as the second element-to-element connection an element-to-element connection which has no capability of being reworked, meaning that where the connection is found to be defective, reworking the connection and therefore eliminating the defect is not feasible.

The solution in accordance with the invention thus allows for technically difficult element-to-element connections to be integrated in the overall process of manufacturing the electrochemical conversion device in such a way that these, when they are defective, lead to reject costs that are as low as possible.

On the other hand, the element-to-element connection that is preferably selected as the first element-to-element connection is the one that is technically less difficult and therefore less susceptible to defects so that the then stacked functional elements can be provided with the first element-to-element connection subject to a very low defect rate.

In particular, the element-to-element connection selected as the first element-to-element connection is also one which does have the capability of being reworked in the event of a defect so that rejects can also be avoided by reworking the first element-to-element connection.

In particular, the scope of the solution in accordance with the invention provides for the second element-to-element connection to be an electrically isolating element-to-element connection.

Such an electrically isolating element-to-element connection may be implemented in a variety of ways.

It is for example conceivable for this element-to-element connection to be provided as a connection between a solder layer and an electrical isolation layer, wherein the solder layer adheres to the isolation layer and wherein for example a metallic layer of the electrical insulation layer may be connected to the solder layer.

Another preferred solution provides for the element-to-element connection to comprise a glass solder layer which itself has an electrically isolating effect.

No details have been provided so far concerning the functional test of the second element-to-element connection.

Preferably, provision is made for the functional test of the second element-to-element connection to comprise a tightness test and/or an electrical isolation test.

With such a functional test, it is possible on the one hand to test for tightness, which is important in electrochemical conversion devices, and also on the other hand to test for the electrical isolation effect of the second element-to-element connection.

Furthermore, it is advantageously provided for the first element-to-element connection to be subjected to a functional test.

For example, such a functional test is likewise a tightness test, which is of substantial importance in the case of an electrochemical conversion device.

A particularly advantageous embodiment of the method in accordance with the invention provides for the functional elements to be stacked into an assembly group and for the functional elements of a respective assembly group to be interconnected by way of the first element-to-element connection insofar as these have not yet been interconnected by way of the second element-to-element connection.

Furthermore, provision is made that for each assembly group the first element-to-element connection, once made, be subjected to a functional test, particularly a tightness test, thereby performing yet another functional test, from assembly group to assembly group.

This can in particular be implemented in that in the manufacture of the electrochemical conversion device an assembly group is created by stacking the functional elements and making the first element-to-element connection between the functional elements and is subjected to a functional test together with any assembly groups that may have already been created.

In particular, it is only after this functional test has been conducted that the next assembly group is created by stacking and by making the first element-to-element connection between the functional elements and is subjected to a functional test together with all of the assembly groups that have already been created.

In conjunction with what has been described above for the method in accordance with the invention, no details have been provided yet as to how to proceed in the case of a negative functional test.

It is preferably provided that in the case of a negative functional test, the defect of the first element-to-element connection be localized and reworked so that a further functional test can be passed.

The functional test, in particular the tightness test, can be performed in different ways.

One advantageous solution provides for the functional test of the first element-to-element connection of the assembly group to be performed at a station for making the first element-to-element connection so that any defect may already be detected at the very station where the first element-to-element connection is made.

In particular, this also allows for the reworking of the first element-to-element connection for passing the functional test to be performed at the station for making the first element-to-element connection, since the assembly group has not left said station yet.

Alternatively, another solution provides that in the case of a negative functional test the assembly group be removed from the production process and, for example, the rework for passing the functional test and the further functional test be performed at a separate station.

In this instance, after having its first element-to-element connection reworked at a separate station and in particular after passing the further functional test, the assembly group can be returned to the production process to continue further processing thereof.

This procedure of creating the assembly groups successively has the advantage that it allows immediate testing, by use of the functional test, each time another assembly group has been created, of whether or not said assembly group and also the assembly groups that have already been created have the required functionality so that in particular in the case of a manufacturing defect associated with creating the last assembly group, this can be localized very quickly and in particular removed by reworking.

Further features and advantages of the invention are the subject of the following description and drawing of the exemplary embodiments.

### BRIEF DESCRIPTION OF THE DRAWINGS

FIG. 1 is a perspective view, partly in section, of a detail of a fuel cell, showing assembly groups stacked one above the other;

FIG. 2 is a top view of a first exemplary embodiment, seen in the direction of arrow A in FIG. 1;

FIG. 3 is an enlarged view of the top view of FIG. 2, showing a first state of compensation;

FIG. 4 is an enlarged view of the top view of FIG. 2, showing a second state of compensation;

FIG. 5 is an enlarged view of peripheral stacks of the assembly groups prior to forming the melt zone;

FIG. 6 is a view similar to FIG. 5, showing the formed connection zone;

FIG. 7 is a view similar to FIG. 5, showing the laser radiation for forming the connection zone;

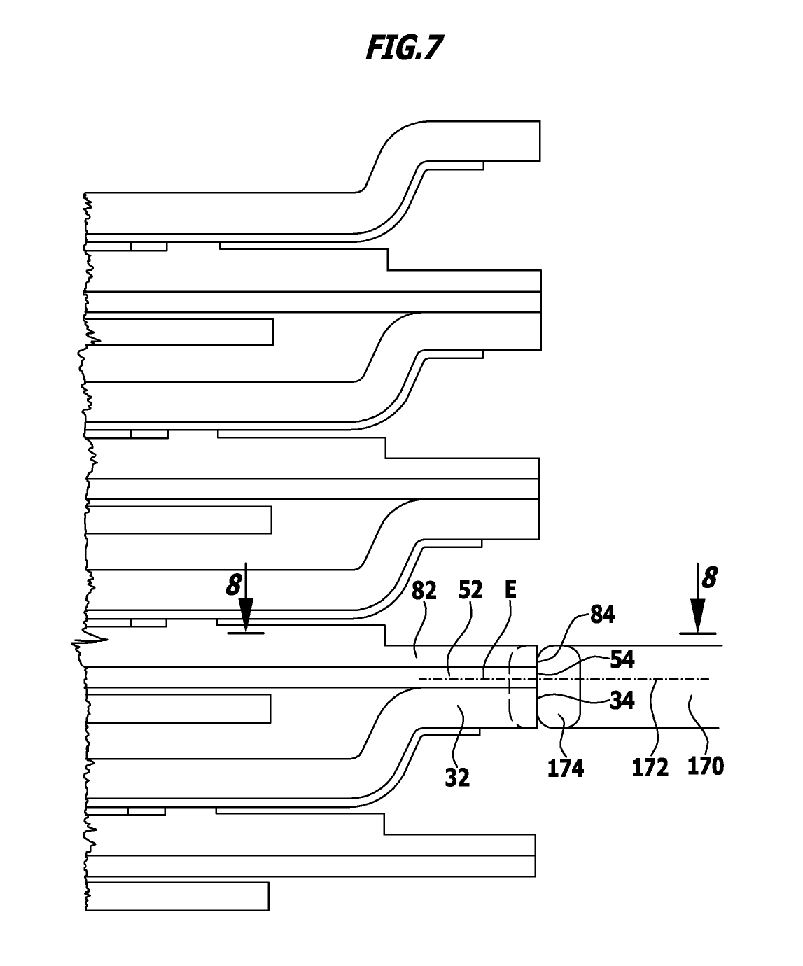

FIG. 8 is a section taken along line 8-8 in FIG. 7;

FIG. 9 is a top view, similar to FIG. 6, of a second exemplary embodiment;

FIG. 10 is a flow chart showing a method in accordance with the invention.

### DETAILED DESCRIPTION OF THE INVENTION

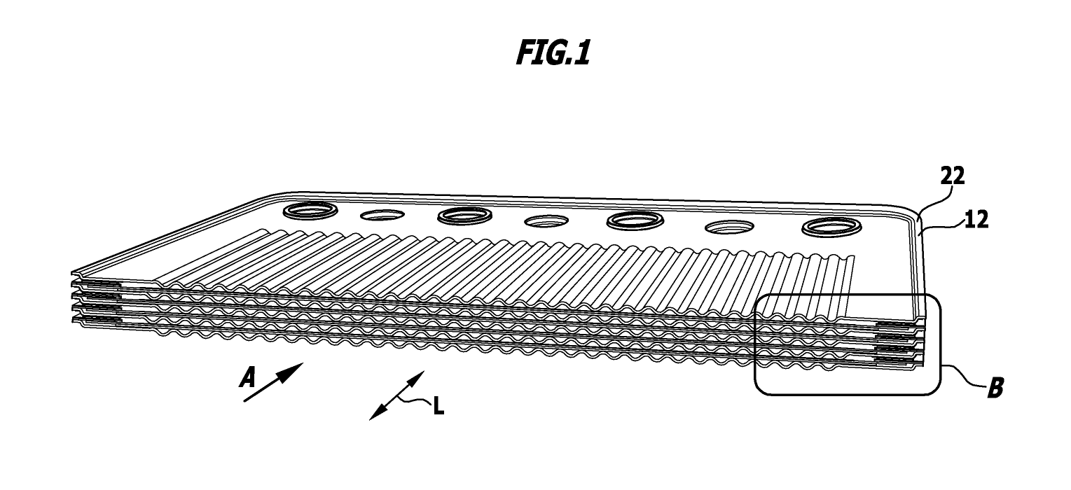

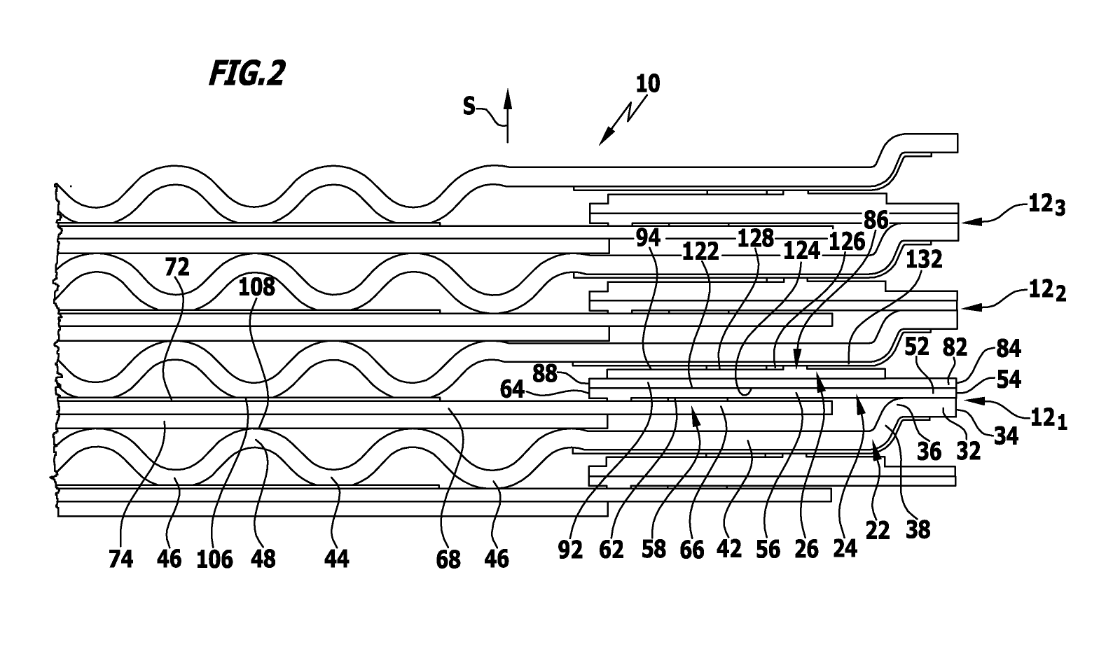

A detail 10 of a fuel cell as an example of an electrochemical conversion device is shown in FIGS. 1 and 2, depicting a plurality of assembly groups 12₁ to 12₃ stacked one above the other in a stacking direction S, each of said assembly groups 12₁ to 12₃ being constructed from a plurality of functional elements 22, 24, 26 stacked one above the other in the stacking direction S, wherein at least a plurality of assembly groups 12 of the fuel cell are constructed from identical functional elements.

For example, the first functional element 22 of each of the assembly groups 12 represents a tray element having an outer peripheral area 32 which surrounds the functional element 22 in a closed manner in the style of a frame, said outer peripheral area 32 terminating in an end face 34 and merging, on an inner side 36 opposite the end face 34, in a tray wall portion 38 extending transversely relative to the outer peripheral area 32 and itself merging in an outer functional area 42 which extends parallel to the outer peripheral area 32 and, on a side opposite the tray wall portion 38, is adjoined by an inner functional area 44 which is configured for example in the form of contacting and flow conducting elements 46, 48 which succeed one another and extend parallel to one another in a longitudinal direction L and which in the present embodiment are shown as being configured as corrugations, but can have other shapes.

The second functional element 24 is configured as a carrier element and comprises an outer peripheral area 52 which surrounds the functional element 24 in a closed manner in the style of a frame and, starting from an end face 54 thereof, extends to a cell carrier 56 which extends in a closed manner as a frame around an inner opening 64 and carries a first fuel cell element 58 which in turn is connected to the cell carrier 56 via a solder layer 62.

The first fuel cell element 58 covers the inner opening 64 enclosed by the cell carrier 56 as a frame and protrudes with a holding periphery 66 thereof so far beyond the inner opening 64 that the holding periphery 66 can be connected to the cell carrier 56 via the solder layer 62.

The first fuel cell element 58 in turn carries, in a functional area 68 thereof extending within the inner opening 64, on a side thereof facing towards the assembly group 12 following next in the stacking direction S, a second fuel cell element 72 and carries, on an opposite side thereof facing towards the inner functional area 44 of the tray element 22 associated with the same assembly group 12, a contact element 74.

The second fuel cell element 72 is for example configured as a layer applied to the functional area 68 of the first fuel cell element 58.

The contact element 74 in turn is for example configured as a coating or sheet and is in contact with the functional area 68 of the first fuel cell element 58.

The third functional element 26 of the assembly group 12 also has an outer peripheral area 82 which surrounds the functional element 26 in a closed manner in the style of a frame and extends, starting from an end face 84 thereof, to a compensating frame 86 which is configured in surrounding relation with an inner frame opening 88. The compensating frame 86 itself is formed from two sheet material layers 92 and 94, for example from spring metal sheets, wherein the sheet material layer 92 represents a base layer which extends from the inner frame opening 88 to the end face 84, thereby comprising the peripheral area 82, and the sheet material layer 94 represents a connection layer which extends from an inner edge 96 thereof to an outer edge 98 thereof which extends for example at a distance from the end face 84.

The base layer 92 and the connection layer 94 have connection areas 102 and 104 respectively which are arranged for example adjacent to the frame opening 88 and the inner edge 96 respectively, these connection areas 102, 104 being interconnected by way of a welded connection 106 and therefore non-movable relative to each other.

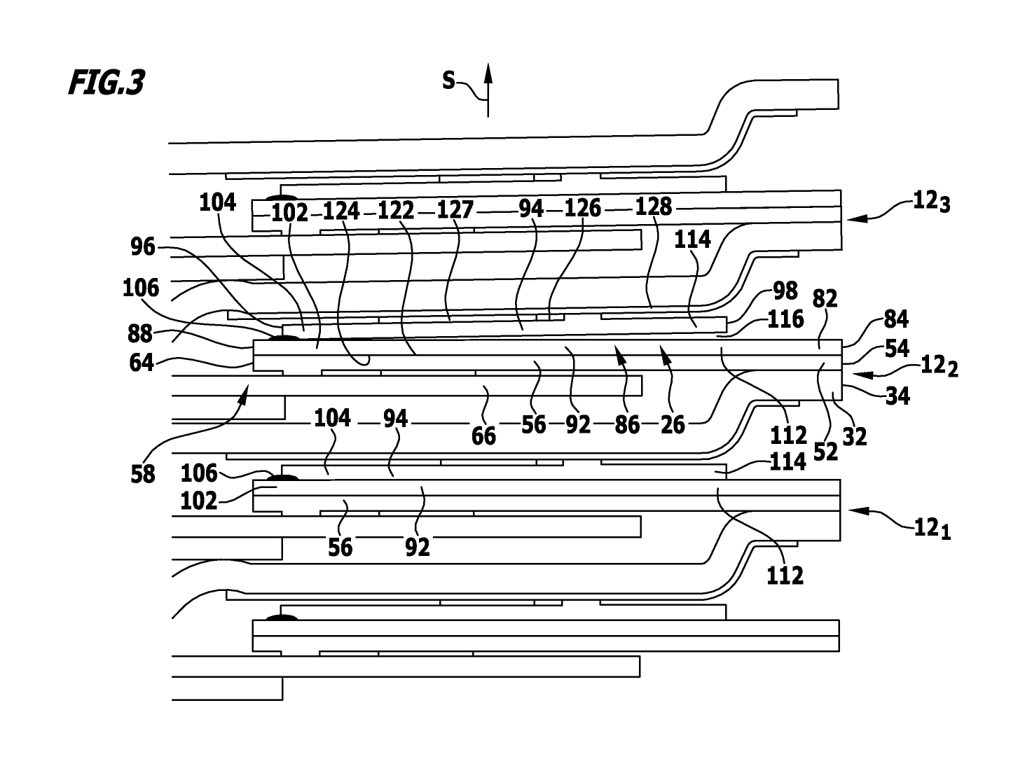

Furthermore, the base layer 92 and the connection layer 94 have movement areas 112 and 114 which are arranged for example facing towards the end face 84, outside of the connection areas 102 and 104 respectively, these movement areas 112 and 114 being movable relative to each other, particularly in the stacking direction S, preferably by the movement areas 112 and 114 being capable of either lying one upon another in contact, or extending in spaced-apart relationship with respect to each other so that an interspace 116 is formed therebetween as is shown in FIG. 3.

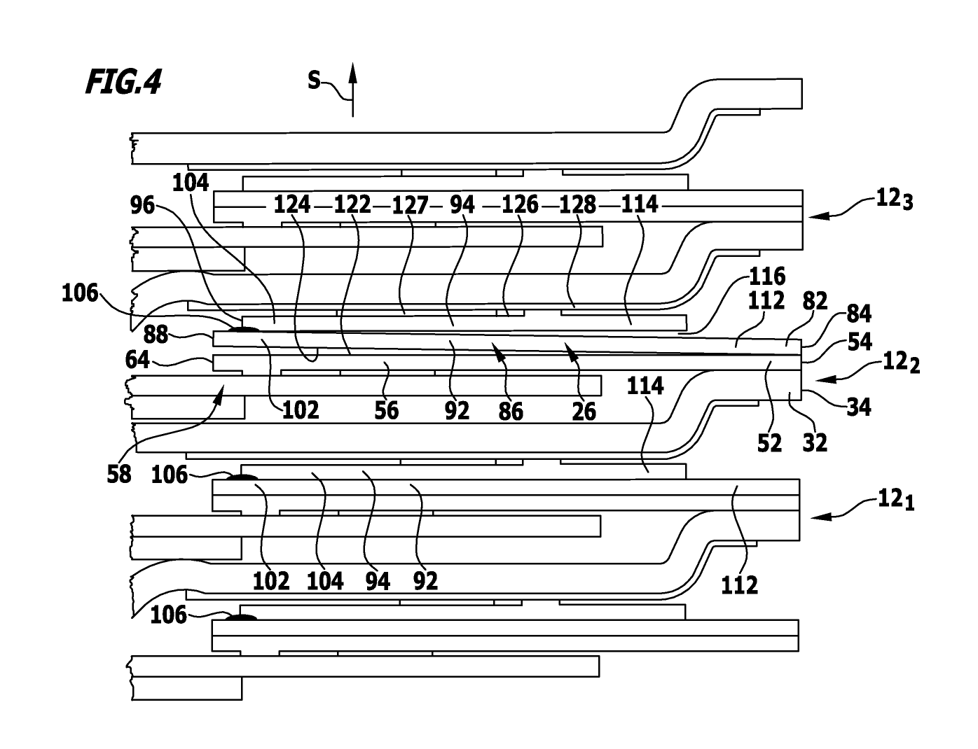

The compensating frame 86 itself can, with a support side 124 of the base layer 92 thereof, be seated on a support side 122 of the cell carrier 56 opposite the holding periphery 66 of the first fuel cell element 58 or, as shown in FIG. 4, with the support side 124 of the connection area 102, it can also be unseated from the support side 122.

A connection side 126 of the compensating frame 86 opposite the support side 124 which is formed by the movement area 114 of the connection layer 94 is connected by way of a solder layer 127 to an electrical isolation layer 128 of the next tray element 22, in the stacking direction S, of the next assembly group 12ₓ₊₁, said electrical isolation layer 128 being for example made from a ceramic material.

Thus, the compensating frame 86 allows for thermal and/or mechanical stresses, such as tensile stresses acting in the stacking direction S, to be compensated and relieves the strain on the joint connections between the individual assembly groups 12, in particular the connections made by the solder layer 127 between the connection side 126 of the compensating frame 86 and the isolation layer 128 of the tray element 22 next to the compensating frame 86, in the stacking direction S, of the next assembly group 12ₓ₊₁.

In particular, the inner opening 64 is configured so as to be in registration with the inner opening 88.

In a fuel cell fabricated from the assembly groups 12 by stacking the assembly groups 12 in the stacking direction S, each assembly group 12ₓ has the respective contact element 74 thereof, which preferably extends within the inner opening 64 of the cell carrier 56, supported on and electroconductively connected with crests 108 of the contacting and flow conducting elements 48 of the inner functional area 44 of the tray element 22 of the same assembly group 12ₓ that face towards the contact element 74, while the second fuel cell element 72 is in contact with and electroconductively connected to the corrugation crests 106 of the contacting and flow conducting elements 46 of the tray element 22 of the next assembly group 12ₓ₊₁ in the stacking direction S so that in each case the second fuel cell element 72 of the one assembly group 12ₓ contacts the tray element 22 of the next assembly group 12ₓ₊₁ in the stacking direction S which itself in turn contacts the contact element 74 that is connected to the first fuel cell element 58 of said next assembly group 12ₓ₊₁.

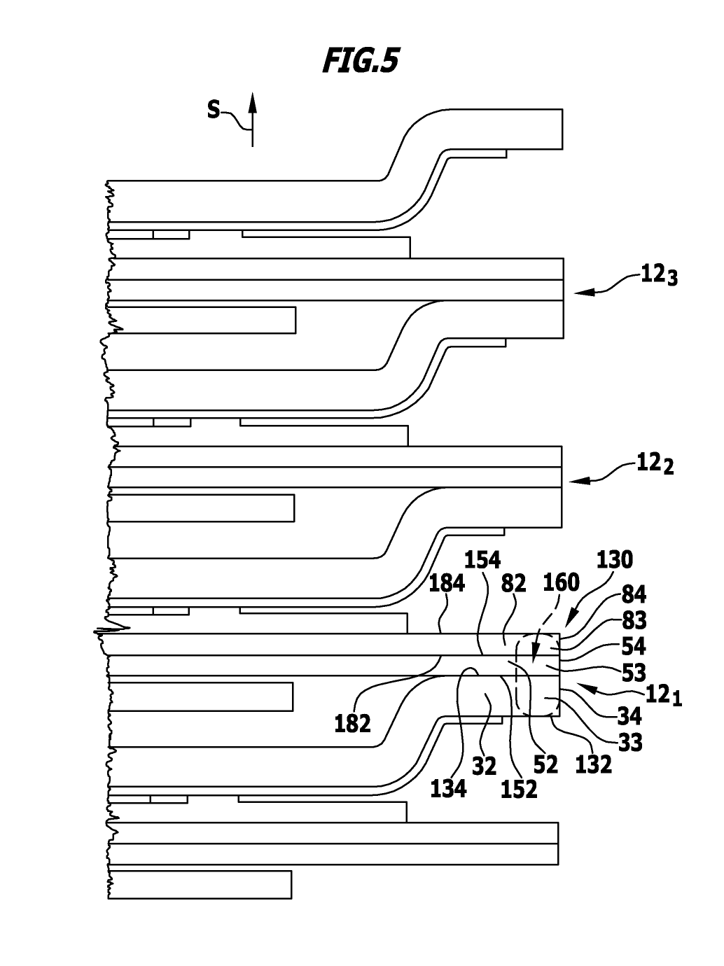

As shown in the enlarged view of FIG. 5, the peripheral areas 32, 52 and 82 of each of the assembly groups 12 together form a peripheral stack 130 in which the peripheral areas 32, 52, 82 are in contact with one another with flat sides thereof.

Thus, by way of example, the peripheral area 32 has a lower flat side 132 and an upper flat side 134. Supported on said upper flat side 134 of the peripheral area 32 is the peripheral area 52 with a lower flat side 152 thereof, while an upper flat side 154 thereof faces towards the peripheral area 82 so that the peripheral area 82 with a lower flat side 182 thereof is supported on the upper flat side 154 of the peripheral area 52 and with an upper flat side 184 thereof faces towards the next assembly group 12.

For interconnecting the peripheral areas 32, 52 and 82 forming the respective peripheral stack 130, a melt zone 160 as shown in FIG. 5 is formed in an end face area 33, 53, 83 adjoining the respective end faces 34, 54, 84 of the peripheral areas 32, 52, 82, wherein the end face areas 33, 53, 83, starting from the end faces 34, 54, 84, extend into the peripheral areas 32, 52, 82 over a portion thereof, namely for a minimum distance that corresponds to a thickness of the one of the peripheral areas 32, 52, 82 that has the smallest thickness and for a maximum distance that corresponds to twice the thickness of the one of the peripheral areas 32, 52, 82 that has the greatest thickness.

In this melt zone 160, a melt is formed by heating a base material of the peripheral areas 32, 52, 82, said melt comprising the base material of the peripheral areas 32, 52, 82.

Where the base material of the peripheral areas 32, 52 and 82 is a metal, such as steel, the melt which results overall in the melt zone 160 is one which represents an alloy of all the constituents present in the peripheral areas 32, 52 and 82.

Where the peripheral areas 32, 52, 82 comprise coatings, these coatings are either burned or evaporated if they are not temperature-resistant enough to withstand the temperature in the melt zone 160, or the materials of the coatings are embedded if they are temperature-stable enough to withstand the temperatures generated in the melt zone 160.

In the latter case, these coatings can be embedded in the melt forming in the melt zone 160. Such coatings are for example metal coatings so that the metals are then integrated in the melt of the melt zone 160.

Where the functional elements are provided with ceramic coatings, as is for example the first functional element 22 with the electrical isolation layer 128, then these are to be arranged such that no ceramic material thereof is arranged in the peripheral areas 32, 52, 82 and thus that none will be integrated in the melt of the melt zone 160.

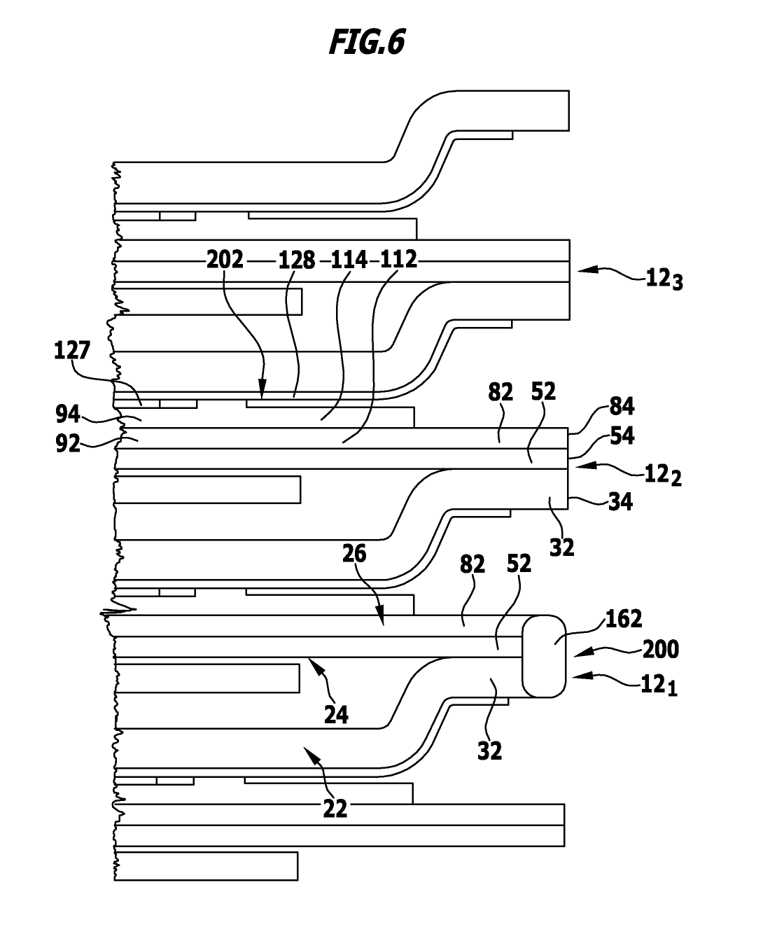

Once the melt zone 160 is hardened, a connection zone 162 is formed which, as depicted in FIG. 6, interconnects all of the peripheral areas 32, 52 and 82 of the respective assembly group 12, thereby also permanently interconnecting all of the functional elements 22, 24 and 26 of the assembly group 12.

For generating the melt zone 160 in the respective assembly groups 12, at least the functional elements 22, 24, 26 of one assembly group 12 are stacked one upon the other in the stacking direction S and have a force applied to them in a direction opposite to the stacking direction S so that all of the peripheral areas 32, 52, 82 lie, with the respective flat sides 134, 152 and 154, 182 thereof, one on top of the other under the application of forces.

Alternatively, however, it is also possible for all of the functional elements 22, 24, 26 of all of the assembly groups 12 to be placed one on top of the other in the stacking direction S and have a force applied to them in a direction opposite to the stacking direction S so that for all of the assembly groups 12 peripheral stacks 130 are formed in which the peripheral areas 32, 52, 82 of the respective functional elements 22, 24, 26 lie, with the flat sides thereof, one on top of the other under the application of forces.

In this condition of the peripheral stacks 130, as shown in FIG. 6, heat is input via the end faces 34, 54, 84 of the peripheral areas 32, 52, 82 by way of a laser beam 170 directed from outside the peripheral stack 130 towards the end faces 34, 54, 84, said laser beam 170 applying heat to all of the end faces 34, 54 and 84 of the respective peripheral stack 130 at the same time, thereby causing the material of the peripheral areas 32, 52, 82 to melt.

The laser beam 170 is oriented such that a beam axis 172 of the laser beam 170 with a plane E parallel to the extension of the peripheral areas 32, 52, 82 encloses an angle smaller than 60°, preferably smaller than 30°, in order to provide for optimal heat application to all of the end faces 34, 54, 84 of the respective peripheral stack 130, thereby causing the respective base material in all of the peripheral areas 32, 52 and 82 to melt.

Furthermore, the laser beam 170 preferably has a focus 174 having an extension which is preferably of the order of the extension of the end faces 34, 54, 84 transverse to the plane E.

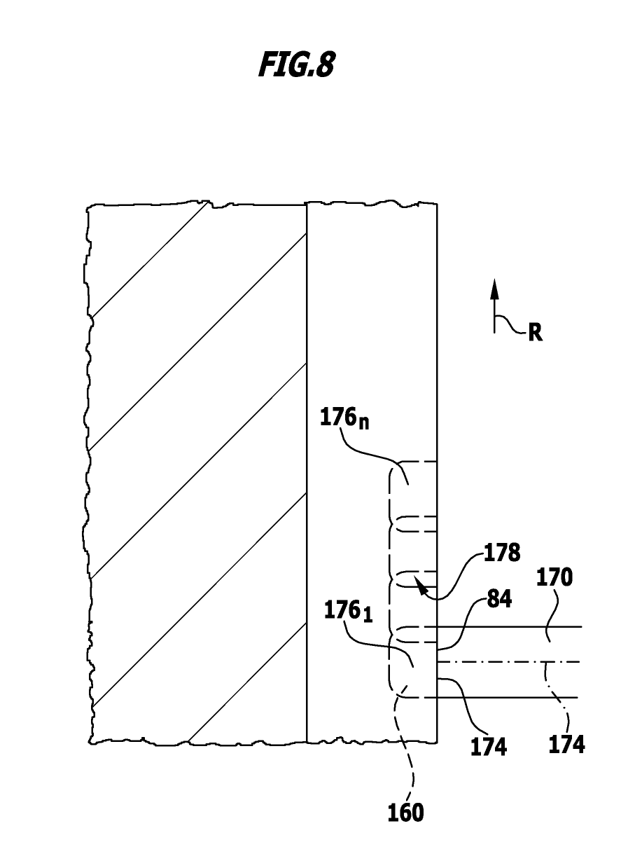

As shown in FIG. 8, this results in the melt zone 160 being formed in an impingement zone 176 of the laser beam 170.

However, if the laser beam 170 is moved along the end faces 34, 54, 84 in a direction R, then this results in impingement zones 176₁ to 176ₙ being formed which overlap one another so that once the melt zones 160 formed in the impingement zones 176₁ to 176ₙ have cooled, a continuous connection zone 162 is formed which interconnects all of the peripheral areas 32, 52, 82 in the respective peripheral stack 130 in a fixed and permanent and in particular gas-tight manner.

If the laser beam 170 is moved along all of the end faces 34, 54, 84 of the peripheral areas 32, 52 and 82 of the respective assembly group 12, it is possible, by virtue of the overlapping impingement zones 176₁ to 176ₙ, for a continuous connection zone 162 to be formed which surrounds the end faces 34, 54, 84 of the whole assembly group 12 in a closed manner, thereby providing in particular a gas-tight connection of all of the peripheral areas 32, 52, 82 of the respective peripheral stack.

The connection zone 162 represents a first element-to-element connection 200 for forming an assembly group 12, whereas the connection of the assembly groups 12 with one another is effected by a second element-to-element connection 202 between the last functional element 26, in the stacking direction S, of one assembly group 12ₓ and the first functional element 22, in the stacking direction S, of the next assembly group 12ₓ₊₁ by way of the solder layer 127 and the isolation layer 128.

Thus, the solution in accordance with the invention affords the possibility of interconnecting the functional elements 22, 24, 26 of the respective assembly group 12 in a permanent and gas-tight manner.

Thus, this method may be used on all of the assembly groups 12 in order to thus provide for a simple and advantageous connection of the peripheral areas 32, 52, 82 in the respective peripheral stacks 130.

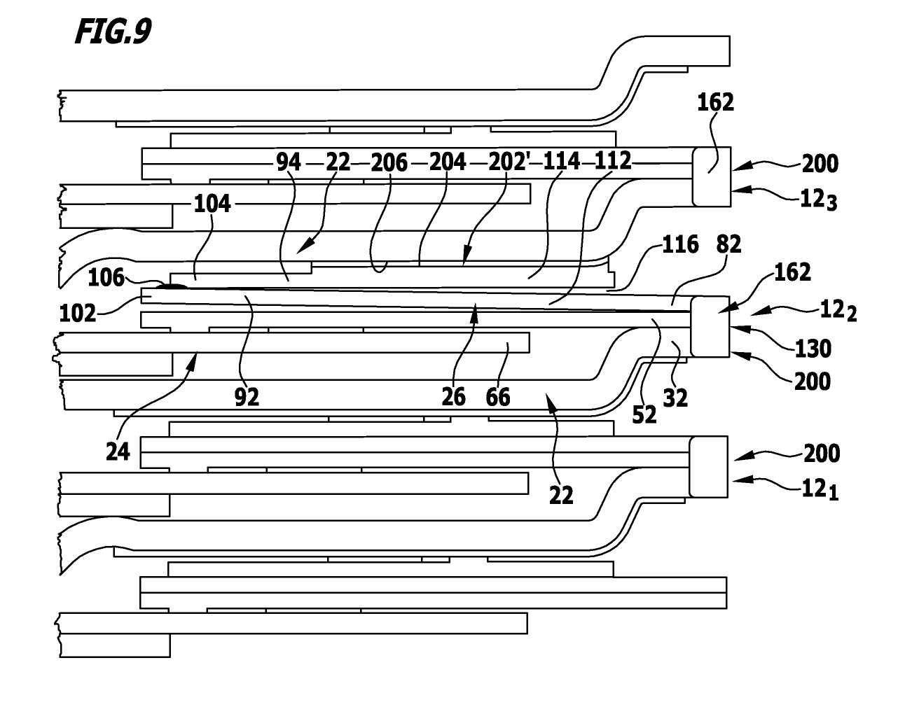

In a second exemplary embodiment of the electrochemical conversion device constructed in accordance with the invention, illustrated in FIG. 9, the second element-to-element connection 202′ is formed by a glass solder connection layer 204 which on the one hand is electrically isolating itself and on the other hand connects the connection side 126 of the compensating frame 86 directly with a support side 206 of the first functional element 22 that faces towards the connection side 126.

Apart from the above, the second exemplary embodiment is identical to the first exemplary embodiment; therefore, the same reference numerals are used in the second exemplary embodiment for parts that are the same as those illustrated in the first embodiment so that reference may be made to what has been described for the case of the first exemplary embodiment.

The above-described method for making the first element-to-element connection 200 may thus be used on all of the assembly groups 12 in order to thus provide in the respective peripheral stack 130 a simple and advantageous connection of the peripheral areas 32, 52, 82 that is easy to repair also in the case of welding defects.

In the manufacture of the fuel cell in accordance with FIG. 1, it would in principle be possible first to interconnect, for each of the individual assembly groups 12₁ to 12ₙ, the functional elements 22, 24, 26 at the peripheral areas 32, 52, 82 thereof by way of the first element-to-element connection 200, followed in each case by connecting the compensating frame 86 of the one functional element 12ₓ with the connection side 126 thereof to the next assembly group 12ₓ₊₁ in the stacking direction S by way of the second element-to-element connection 202 comprising the solder layer 127 and the isolation layer 128 of the tray element 22, as described for the first exemplary embodiment, or, as described for the second exemplary embodiment, to provide for a connection using the glass solder connection layer 204 instead of the connection between the solder layer 127 and the isolation layer 128.

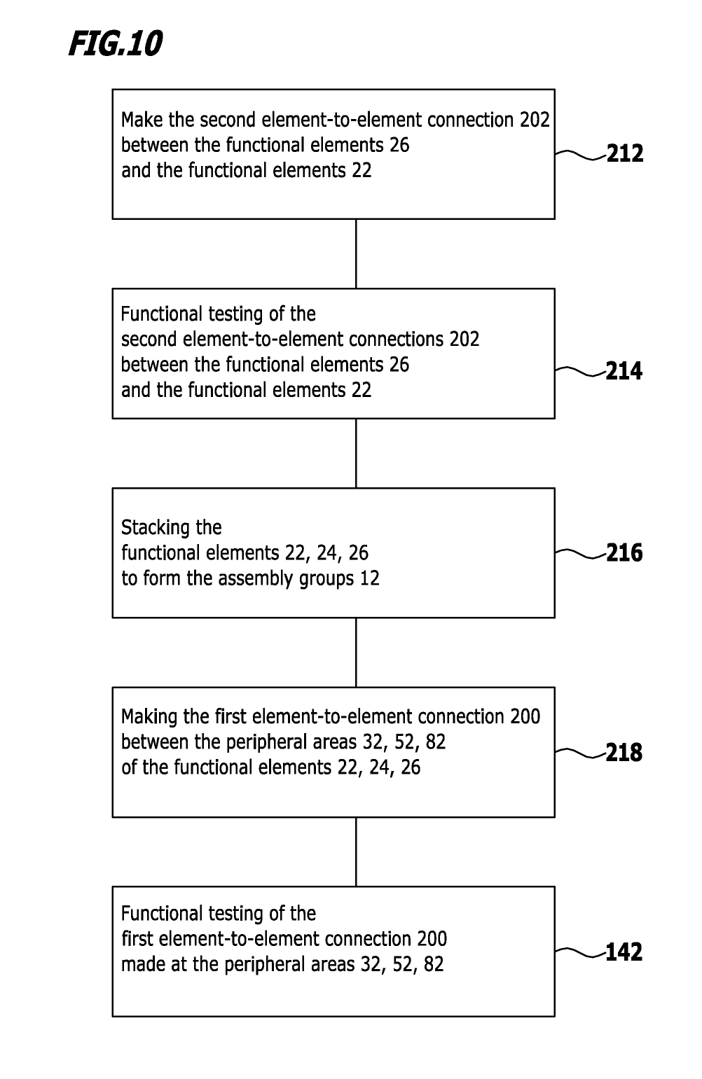

However, a particularly advantageous embodiment of the method in accordance with the invention as illustrated in the flow chart of FIG. 10 provides, as a first step 212, prior to making the first element-to-element connection 200 between the peripheral areas 32, 52, 82 of the individual functional elements 22, 24, 26, for making the second element-to-element connection 202 between the third functional elements 26 of a respective assembly group 12ₓ that are to be used in the fuel cell and the corresponding first functional elements 22 of the respective next assembly group 12ₓ₊₁.

This is followed, as shown in FIG. 10, by a functional test 214 in the form of a pressure test of the second element-to-element connection 202 between the third functional elements 26 and the first functional elements 22 and a conductivity test of the second element-to-element connection 202 between the first functional elements 22 and the third functional elements 26, wherein the pressure test and the conductivity test may be performed in any order, i.e. the conductivity test may be performed first and then the pressure test or, conversely, the pressure test may be performed first and then the conductivity test, or the two tests may be performed at the same time.

The advantage of this solution is seen in that it allows the second element-to-element connection 202 between the third functional element 26 and the corresponding first functional element 22, which is technically difficult to perform and which, while it must be pressure-resistant on the one hand, must not be electrically conductive on the other hand, to be made first so that here if the connection is found not to be pressure-resistant or found to be conductive, the interconnected functional elements 26, 22 can be considered as reject parts and precluded from use.

The next step involves stacking 216 the functional elements 22, 24, 26 of the first assembly group 12₁ or of all of the assembly groups 12₁ to 12ₙ simultaneously.

Next, in a further step 218, the respective functional elements 22, 24, 26 of the assembly groups 12 are interconnected by making the first element-to-element connection 200 at the peripheral areas 32, 52, 82 thereof in the manner described above.

In making the first element-to-element connection 200 at the peripheral areas 32, 52, 82 of the respective functional elements 22, 24, 26, there are also further possibilities for proceeding.

For example, after stacking 216 the functional elements 22, 24, 26 of the first assembly group 12₁, wherein the compensating frame 86 is already connected to the tray element 22, the first element-to-element connection 200 at the peripheral areas 32, 52, 82 of the first assembly group 12₁ is made, this being followed, prior to stacking 216 the further functional elements 24, 26 of the second assembly group 12₂, by a pressure test of the first assembly group 12₁ along with the tray element 22 of the next assembly group 12₂ connected thereto.

If a leak is detected after making the first element-to-element connection 200 at the peripheral areas 32, 52, 82, then, once the leak is localized, the connection zone 162 can be re-worked, for example re-welded, at the leak location before proceeding to the steps of stacking 216 and making the first element-to-element connection 200 of the peripheral areas 32, 52, 82 between the functional elements 24, 26 and the functional element 22 of the second assembly group 12₂.

Thus, when the first element-to-element connections 200 of the assembly groups 12₁₋ₙ are made successively, it is possible for each of the first element-to-element connections at the peripheral areas 32, 52, 82 of each individual assembly group 12ₓ to be tested for tightness and, if required, reworked.

Therefore, the advantage of this solution is on the one hand that there is the possibility of having the technically critical second element-to-element connection 202 between the functional element 26 and the functional element 22 made first, then having it tested extensively for its functions such as tightness and isolation and only after that having the technically simpler first element-to-element connection 200 at the peripheral areas 32, 52 and 82 made and, if found to be defective, reworked.

1. Electrochemical conversion device, comprising a plurality of functional elements stacked one upon the other into a stack in a stacking direction and interconnected within the stack, some of which have peripheral areas of sheet material, some of which are arranged in a stacked configuration one upon the other in a stacking direction, forming peripheral stacks, and are interconnected by way of a first element-to-element connection and some others of which are interconnected by way of a second element-to-element connection, one of the functional elements comprising a compensating unit and the compensating unit comprising at least one deformable element which, by deformation, allows for at least one height compensation in the stacking direction.

2. Conversion device as defined in claim 1, wherein the compensating unit is connected to the adjacent functional elements on the one hand by way of the first element-to-element connection and on the other hand by way of the second element-to-element connection.

3. Conversion device as defined in claim 1, wherein the compensating unit comprises at least one sheet material layer as the deformable element for height compensation.

4. Conversion device as defined in claim 1, wherein the compensating unit comprises at least two sheet material layers that are movable relative to each other in the stacking direction.

5. Conversion device as defined in claim 4, wherein the at least two sheet material layers are interconnected in connection areas and are movable relative to each other in the stacking direction in movement areas located outside the connection areas.

6. Conversion device as defined in claim 5, wherein the sheet material layers are interconnected in the connection areas by way of a substance-to-substance bond.

7. Conversion device as defined in claim 6, wherein the substance-to-substance bond between the sheet material layers is located on a side of the compensating unit that faces away from the peripheral area.

8. Conversion device as defined in claim 5, wherein the connection areas of the sheet material layers are arranged on a side of the compensating unit that faces away from the peripheral area of the respective functional element.

9. Conversion device as defined in claim 5, wherein the movement areas of the sheet material layers lie one on top of the other in a first position and extend at a distance from one another in at least one second position.

10. Conversion device as defined in claim 5, wherein the movement areas are arranged on a side of the compensating unit that faces towards the peripheral area.

11. Conversion device as defined in claim 1, wherein one of the sheet material layers of the compensating unit is connected to the adjacent functional element in the stacking direction by way of a peripheral area and the first element-to-element connection.

12. Conversion device as defined in claim 1, wherein one of the sheet material layers of the compensating unit is connected to the adjacent functional element in the stacking direction by way of the second element-to-element connection.

13. Conversion device as defined in claim 1, wherein one of the element-to-element connections is an electrically isolating element-to-element connection.

14. Conversion device as defined in claim 1, wherein one of the element-to-element connections is an electrically conductive element-to-element connection.

15. Conversion device as defined in claim 1, wherein the second element-to-element connection is substance-to-substance bond.

16. Conversion device as defined in claim 13, wherein the second element-to-element connection comprises a solder connection.

17. Conversion device as defined in claim 1, wherein the first element-to-element connection is a substance-to-substance bond.

18. Conversion device as defined in claim 17, wherein the substance-to-substance bond is a welded connection comprising a connection zone.

19. Conversion device as defined in claim 18, wherein the peripheral areas extend to end faces succeeding one another in the stacking direction, wherein the end faces of the respective peripheral stacks are arranged relative to one another such that they are within the connection zone.

20. Conversion device as defined in claim 18, wherein the connection zone is configured in surrounding relation with the functional elements of the respective assembly group.

21. Conversion device as defined in claim 18, wherein the connection zone is configured such that it interconnects all of the peripheral areas of the respective assembly group in a gas-tight manner.

22. Conversion device as defined in claim 18, wherein an end face area in which the connection zone is formed extends starting from the end faces of the peripheral areas into the peripheral areas by a distance no greater than that corresponding to twice the thickness of one of the peripheral areas.

23. Method for manufacturing an electrochemical conversion device from individual functional elements that are interconnected in a stack, wherein a second element-to-element connection between some of the functional elements is made first, wherein the second element-to-element connection is subjected to a functional test, wherein thereafter stacking of the functional elements is performed and wherein subsequently any stacked functional elements not yet connected by the second element-to-element connection are interconnected by way of a first element-to-element connection.

24. Method as defined in claim 23, wherein the second element-to-element connection is an electrically isolating element-to-element connection.

25. Method as defined in claim 23, wherein the functional test of the second element-to-element connection comprises at least one of a tightness test and an electrical isolation test.

26. Method as defined in claim 23, wherein the first element-to-element connection is subjected to a functional test.

27. Method as defined in claim 23, wherein the functional elements are stacked into an assembly group and wherein the functional elements of a respective assembly group are interconnected by way of the first element-to-element connection.

28. Method as defined in claim 27, wherein in the manufacture of the electrochemical conversion device an assembly group is created by stacking the functional elements and by making the first element-to-element connection between the functional elements and is subjected to a functional test together with any assembly groups that may have already been created.

29. Method as defined in claim 28, wherein only after this functional test the next assembly group is created by stacking and making the first element-to-element connection between the functional elements and subjected to a functional test together with all of the assembly groups that have already been created.

30. Method as defined in claim 28, wherein in the case of a negative functional test, the leak of the first element-to-element connection is localized and reworked.

31. Method as defined in claim 28, wherein the functional test of the first element-to-element connection is performed at a station for making the first element-to-element connection.

32. Method as defined in claim 28, wherein the reworking of the first element-to-element connection is performed at the station for making the first element-to-element connection.

33. Method as defined in claim 28, wherein in the case of a negative functional test the assembly group is removed from the production process.
